(19) United States
(12) Patent Application Publication
(10) Pub. No.: US 2025/0014465 A1
(43) Pub. Date: Jan. 9, 2025

(54) TRAFFIC MONITORING APPARATUS, TRAFFIC MONITORING SYSTEM, AND METHOD FOR IMPROVING TRAVEL MOBILITY AS A SERVICE (MAAS)

(71) Applicant: TOYOTA JIDOSHA KABUSHIKI KAISHA, Toyota-shi Aichi-ken (JP)

(72) Inventor: Hiroyasu HONDA, Toyota-shi Aichi-ken (JP)

(73) Assignee: TOYOTA JIDOSHA KABUSHIKI KAISHA, Toyota-shi Aichi-ken, (JP)

(21) Appl. No.: 18/762,016

(22) Filed: Jul. 2, 2024

(30) Foreign Application Priority Data
Jul. 5, 2023 (JP) 2023-110974

(51) Int. Cl. G08G 1/09; G08G 1/0965; G08G 1/0968

(52) U.S. Cl. CPC G08G 1/091; G08G 1/0965; G08G 1/0968

(57) ABSTRACT

A traffic monitoring apparatus of the present disclosure includes a communication interface and a controller. The communication interface is configured to acquire travel information pertaining to travel of a plurality of mobile objects including a vehicle, and communicate with the vehicle. The controller is configured to set exclusive areas around the mobile objects based on the travel information, and generate a notification to be transmitted to a specific vehicle when an exclusive area around the specific vehicle and one or more exclusive areas for the mobile objects other than the specific vehicle overlap with each other.

### CROSS-REFERENCE TO RELATED APPLICATION

This application claims priority to Japanese Patent Application No. 2023-110974, filed on Jul. 5, 2023, the entire contents of which are incorporated herein by reference.

### TECHNICAL FIELD

The present disclosure relates to a traffic monitoring apparatus, a traffic monitoring system, and a method for improving travel mobility as a service (MaaS).

### BACKGROUND

A driving assistance apparatus that sets a determination area ahead of a vehicle has been proposed. For example, see Patent Literature (PTL) 1. The driving assistance apparatus assumes that there is a collision risk and notifies the driver of the vehicle of a warning when at least a part of a preceding vehicle overlaps with the determination area.

### CITATION LIST

### Patent Literature

PTL 1: JP 2021-062760 A

### SUMMARY

In the conventional technology, the determination area is set only ahead of the vehicle subject to the driving assistance and the collision risk with the preceding vehicle that is traveling ahead of the vehicle is determined. Therefore, in the conventional technology, a large determination area needs to be set to ensure safety, which may result in the occurrence of unnecessary deceleration and/or awkward movements. In addition, the conventional technology does not take into account the presence of vehicles other than the preceding vehicle, mobile objects other than the vehicles, such as bicycles, personal mobility vehicles (PMVs), and pedestrians, as well as their traveling states.

It would be helpful to improve technology related to avoiding the collision of mobile objects in road traffic.

A traffic monitoring apparatus according to an embodiment of the present disclosure includes:
a communication interface configured to:
   acquire travel information pertaining to travel of a plurality of mobile objects including a vehicle; and
   communicate with the vehicle; and
a controller configured to:
   set exclusive areas around the mobile objects based on the travel information; and
   generate a notification to be transmitted to the vehicle when an exclusive area around the vehicle and one or more exclusive areas for the mobile objects other than the vehicle overlap with each other.

According to the present disclosure, technology related to avoiding the collision in road traffic can be improved.

### BRIEF DESCRIPTION OF THE DRAWINGS

In the accompanying drawings:

FIG. 1 is a block diagram illustrating a schematic configuration of a traffic monitoring system according to an embodiment of the present disclosure;

FIG. 2 is a diagram illustrating an example of traffic on a road monitored by the traffic monitoring system in FIG. 1;

FIG. 3 is a diagram illustrating an example of an exclusive area when a vehicle travels straight;

FIG. 4A is a diagram illustrating an example of an exclusive area when the vehicle changes the travel direction;

FIG. 4B is a diagram illustrating an example of an exclusive area when the vehicle changes the travel direction;

FIG. 5A is a diagram illustrating an example of an exclusive area for a mobile object;

FIG. 5B is a diagram illustrating an example of an exclusive area for a mobile object;

FIG. 5C is a diagram illustrating an example of an exclusive area for a mobile object; and

FIG. 6 is a flowchart illustrating a procedure for a traffic monitoring method performed by a traffic monitoring apparatus.

### DETAILED DESCRIPTION

An embodiment of the present disclosure will be described below with reference to the drawings. The drawings used in the following description are schematic. Dimensions, ratios, and the like on the drawings do not necessarily match actual ones.

### (Configuration of Traffic Monitoring System)

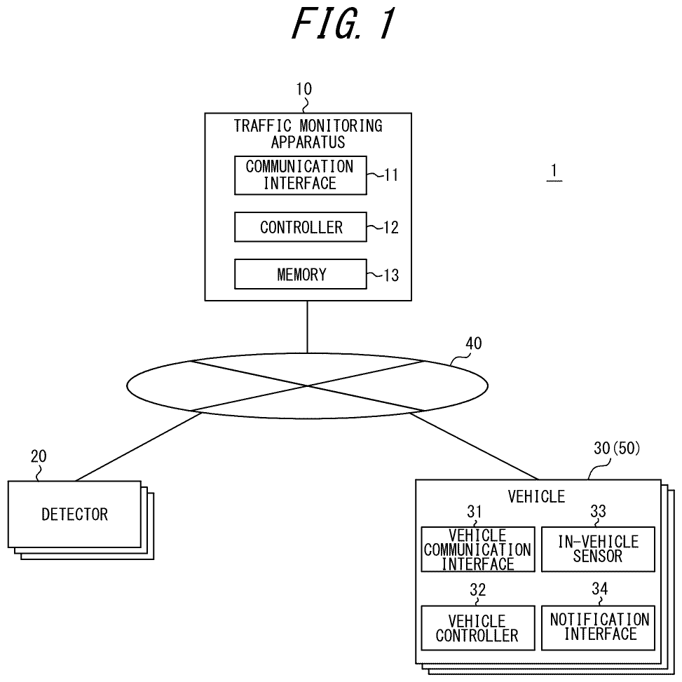

A traffic monitoring system 1 according to one embodiment of the present disclosure includes a traffic monitoring apparatus 10, one or more detectors 20, and one or more vehicles 30, as shown in FIG. 1. The communicably connection between the traffic monitoring apparatus 10 and the detector 20, and between the traffic monitoring apparatus 10 and the vehicle 30, is made by wired and/or wireless communication device via a dedicated network or a network 40 such as a VPN (Virtual Private Network).

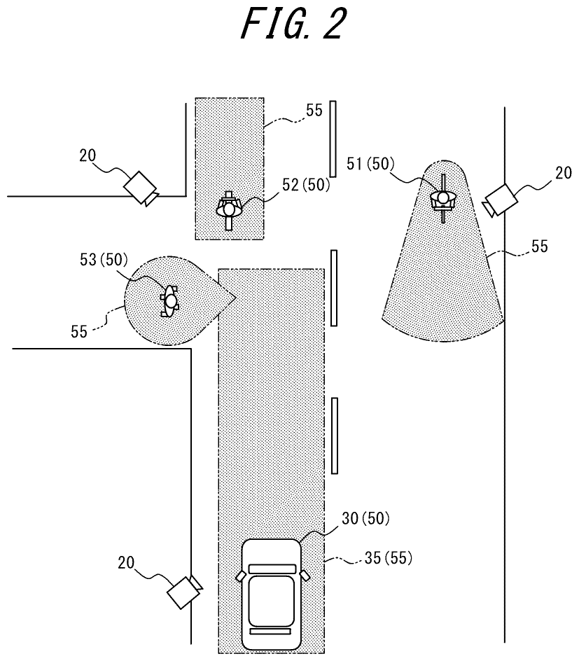

The traffic monitoring apparatus 10 is a computer that monitors road traffic. The traffic monitoring apparatus 10 acquires information about the travel of mobile objects 50 (see FIG. 2) including the vehicles 30 traveling on the road to be monitored, from the detectors 20 and/or the vehicles 30 installed on the road infrastructure to determine whether there is a risk of collision between the vehicles 30 and other mobile objects 50. An example of a vehicle 30 traveling on a road in FIG. 2 and a mobile object 50 is shown. If the traffic monitoring apparatus 10 determines that there is a risk of a collision occurring, it notifies the vehicles 30 at risk of being involved in a collision.

In the following, information about the travel of the mobile objects 50 is referred to as travel information. The travel information includes information on the positions of the mobile objects 50, the speeds of the mobile objects 50, and the travel directions of the mobile objects 50. The travel information may further include information on the types of the mobile objects 50, the wet/dry condition of the road surface on which the mobile objects 50 pass, and the steering angles of vehicles 30 when the mobile objects 50 are the vehicles 30. The travel information may be acquired from at least any of the detectors 20 and the vehicle 30.

The mobile objects 50 include bicycles 51, personal mobility vehicles (PMVs) 52, and pedestrians 53 traveling on the road. The mobile objects 50 may further include the vehicle 30. In other words, when the traffic monitoring apparatus 10 focuses on a specific vehicle 30 to determine the risk of collision, the other vehicles 30 may be treated as mobile objects 50.

In an embodiment, the traffic monitoring apparatus 10 and the traffic monitoring system 1 may be used to provide MaaS, a service that leverages mobility. The term “MaaS” is an abbreviation of Mobility as a Service.

As illustrated in FIG. 1, the traffic monitoring apparatus 10 includes a communication interface 11, a controller 12, and a memory 13.

The communication interface 11 includes a communication interface for communicating with apparatuses external to the traffic monitoring apparatus 10. The external apparatuses include the detector 20 and the vehicle 30. The communication interface 11 supports wired and/or wireless communication. The communication interface 11 communicates with the detector 20 and the vehicle 30.

The controller 12 is configured with a single processor or a plurality of processors and a memory. Processors include general purpose processors that execute programmed functions by loading a specific program, and dedicated processors that are dedicated to specific processing. The controller 12 can read a program for traffic monitoring and execute various processes for traffic monitoring. The controller 12 integrates the information acquired from the multiple detectors 20 and the information acquired from the multiple vehicles 30 to determine the risk of a collision of the vehicle 30 with another mobile object 50. The controller 12 generates a notification for the vehicle 30 that is determined to be at risk of collision and transmits this notification to the vehicle 30 by the communication interface 11. Processing executed by the traffic monitoring apparatus 10 can be referred to as that executed by the controller 12.

The memory 13 includes at least one semiconductor memory, at least one magnetic memory, at least one optical memory, or a combination of at least two of these. The memory 13 functions as, for example, a main memory, an auxiliary memory, or a cache memory. The memory 13 stores programs and data to be used for the operations of the traffic monitoring apparatus 10 and data obtained by the operations of the traffic monitoring apparatus 10. Each piece of information stored in the memory 13 may be updated with, for example, information acquired from the communication interface 11.

For example, the memory 13 may store a map of the roads in the area to be monitored by the traffic monitoring apparatus 10. The memory 13 may also store the position of and detectable area of each of the detectors 20 in association with a map of the road. In addition, the memory 13 may store various parameters needed to set exclusive areas 35 and 55 (see FIG. 2).

The detector 20 is a sensor that detects mobile objects 50 including vehicles 30 on the road. The detector 20 may be arranged in large numbers within the area to be monitored by the traffic monitoring system 1. The detector 20 may include AI cameras, ultrasonic detectors, optical beacons, LiDAR (Light Detection And Ranging), etc. For example, the detector 20 may be an edge AI camera with AI processing capability, recognize the position, speed and travel direction of the detected mobile object 50, and transmit the recognized information on the mobile object 50 together with the image of the mobile object 50 to the traffic monitoring apparatus 10. Such a recognition process of the mobile objects 50 may be performed by the traffic monitoring apparatus 10 based on images acquired from the camera. The detector 20 transmits information about the travel of the mobile objects 50 to the traffic monitoring apparatus 10 as travel information.

The vehicles 30 include, but are not limited to, passenger cars, trucks, buses, and large and small special-purpose automobile. The vehicles 30 include various types of vehicles 30 that will be realized in the future. The vehicle 30 can communicate with the traffic monitoring apparatus 10 and can receive notifications from the traffic monitoring apparatus 10. The vehicle 30 may be able to inform the driver of the received notification by image and sound.

The vehicle 30 includes, for example, a vehicle communication interface 31, a vehicle controller 32, an in-vehicle sensor 33, and a notification interface 34.

The vehicle communication interface 31 includes at least one interface for external communication for connecting to the network 40 by wireless communication. Examples of the interface for external communication include an interface compliant with mobile communication standards, such as the 4th Generation (4G) mobile communication system such as Long Term Evolution (LTE), or the 5th Generation (5G) mobile communication system. The vehicle communication interface 31 can transmit travel information for the vehicle 30 to the traffic monitoring apparatus 10. The vehicle communication interface 31 can receive notifications from the traffic monitoring apparatus 10 indicating the risk of collision with other mobile objects 50.

The vehicle controller 32 is configured to, as is the case with the controller 12 of the traffic monitoring apparatus 10, include a single processor or a plurality of processors and a memory. The vehicle controller 32 may be the controller of an information processing apparatus installed in the vehicle 30. The vehicle controller 32 may transmit the travel information for the vehicle 30 obtained as a result of processing the output of the in-vehicle sensors 33 to the traffic monitoring apparatus 10 via the vehicle communication interface 31. Based on the notification from the traffic monitoring apparatus 10 received via the vehicle communication interface 31, the vehicle controller 32 can use the notification interface 34 to inform the driver of the risk of a collision occurring.

The in-vehicle sensor 33 may include sensors that detect the position, speed, and travel direction of the vehicle 30. For example, the in-vehicle sensors 33 include a vehicle speed sensor, a steering angle sensor, and an orientation sensor such as a gyro sensor. The in-vehicle sensor 33 may also include a receiving apparatus compliant with Global Navigation Satellite System (GNSS). The receiving apparatus compliant with GNSS includes a Global Positioning System (GPS) receiver. The vehicle 30 can transmit this information to the traffic monitoring apparatus 10 as the travel information. The in-vehicle sensor 33 may further include a camera that captures images of the road surface on which the vehicle 30 is traveling. The vehicle controller 32 may analyze the camera images to determine the wet/dry condition status of the road surface and transmit the results of this determination to the traffic monitoring apparatus 10.

The notification interface 34 informs the driver of the vehicle 30 of the notification received from the traffic monitoring apparatus 10. The notification interface 34 may include, for example, a display apparatus such as a liquid crystal display (LCD) and an organic electro-luminescent (EL) display. The notification interface 34 may also include a speaker for audibly notifying the user of the notification. The notification interface 34 can inform the driver of the vehicle 30 with images and sounds of instructions, including deceleration and stopping, in accordance with the notification received from the traffic monitoring apparatus 10.

The vehicle 30 may be an autonomous vehicle capable of at least partially autonomous driving. The automated driving may include, for example, any level from Level 1 to Level 5 as defined by the Society of Automotive Engineers (SAE), but is not limited to these, and may be defined in any way. In this case, upon receiving a notification from the traffic monitoring apparatus 10, the vehicle 30 may be configured to use the received notification to perform control of driving. In other words, the vehicle 30 may control its operation by integrating the information collected by its own sensors and the information acquired from the traffic monitoring apparatus 10.

### (Determination of Collision Risk)

Below, with reference to FIG. 2, the method of determining the risk of a collision occurring by the traffic monitoring system 1 is explained. In the area to be monitored by the traffic monitoring system 1, a number of detectors 20 are placed along the road. The detectors 20 may be arranged to cover the roads in the area to be monitored. The detectors 20 may also be focused on specific intersections or areas of high accident frequency, etc.

The controller 12 of the traffic monitoring apparatus 10 calculates an exclusive area 55 around the mobile objects 50 including the vehicle 30, based on the information acquired from the detector 20 and the vehicle 30. The exclusive area 55 is determined by considering the travel information including the current position, speed, and travel direction of the mobile objects 50. The exclusive area 55 is the area where a collision may not be avoided when another mobile object 50 intrudes. Therefore, it is desirable that there are no other mobile objects 50 in the exclusive area 55 for one mobile object 50.

The controller 12 can set the shape of the exclusive area 55 based on the types of mobile object 50. The types of mobile objects 50 include, for example, bicycles 51, PMVs 52, and pedestrians 53, in addition to vehicles 30. The types of mobile objects 50 are not limited to these. The shape of the exclusive area 55 takes into account the characteristics of the travel of each type of mobile object 50, as described below.

The exclusive area 55 extends from the position of the mobile object 50 in the travel direction of the mobile object 50. The length of the exclusive area 55 in the travel direction varies with the speed of the mobile object 50. The faster the speed of the mobile object 50, the longer the length of the exclusive area 55 in the travel direction.

The controller 12 of the traffic monitoring apparatus 10 arranges exclusive areas 55 in a virtual space that reflects the real-life positioning of the mobile objects 50 and determines that when the exclusive areas 55 for two or more different mobile objects 50 overlap with each other, these two or more mobile objects 50 are at risk of colliding. For example, in the FIG. 2 example, the controller 12 determines that there is a risk of a collision between the vehicle 30 and the pedestrian 53 because the exclusive area 35 for the vehicle 30 and the exclusive area 55 for the pedestrian 53 overlap with each other. If a vehicle 30 is included in the mobile objects 50 that may collide, the controller 12 generates a notification of the possibility of a collision, designating this as a specific vehicle 30. The controller 12 transmits the generated notification to the specific vehicle 30 via the communication interface 11. In this way, the traffic monitoring apparatus 10 can predict that a collision will occur between the vehicle 30 and another mobile object 50 and send a notification to the vehicle 30 to avoid the collision.

### (How to Set Exclusive Areas)

As mentioned above, the exclusive areas 35 and 55 are determined by calculation according to the type of mobile objects 50. The length of the exclusive areas 35 and 55 in the travel direction is determined based on the total length of the braking distance and the reaction distance of each type of mobile object 50. This causes the exclusive areas 35 and 55 to expand and contract in response to the speed of the mobile object 50.

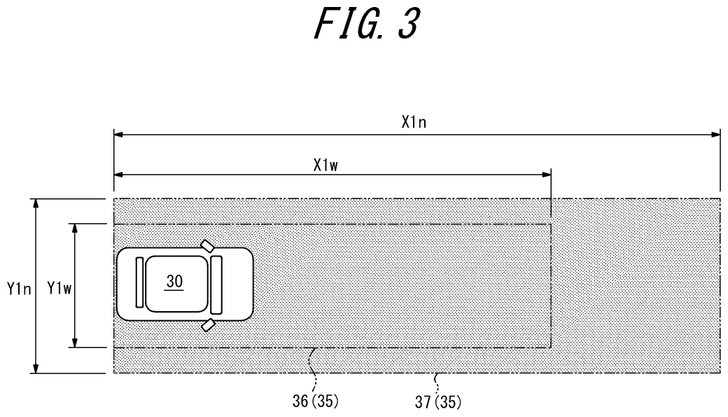

FIG. 3 illustrates an example of how to set up an exclusive area 35 for a vehicle 30. In the FIG. 3 example, the exclusive area 35 includes an alarm area 36 and a notification area 37. The notification area 37 is wider than the alarm area 36.

The warning area 36 is, for example, a rectangular area that has a long side extending in the travel direction of the vehicle 30 and a short side extending in the vehicle width direction of the vehicle 30 and includes the vehicle 30. X1w and Y1w in FIG. 3 are the lengths of the long and short sides of the alarm areas 36, respectively. X1w and Y1w can be set as follows. The values of α1 to α4 and β1 to β3 in the following equations are constants that are set individually in each equation.

$$X 1 w [ m ] = total vehicle length [ m ] + reaction distance [ m ] + braking distance [ m ] \\ Reaction distance [ m ] = reaction time 1.5 [ s ] \times vehicle speed [ km / h ] / 3600 \times 1000 \\ Braking distance [ m ] = {( speed [ km / h ] )}^{2} / ( 254 \times coefficient of friction ) \\ Y 1 w [ m ] = car width [ m ] + α1 [ m ]$$

The coefficient of friction used to calculate the braking distance is calculated, for example, based on information on the detectors 20 installed on the road infrastructure. The controller 12 may, for example, acquire images from the detector 20, which is a camera, and recognize the condition of the road surface from the images of the road surface. The controller 12 may also acquire information from the vehicle 30 on the wet/dry condition of the road surface on which the vehicle 30 passes. The controller 12 increases the braking distance when the road surface is wetter than when the road surface is dry. The coefficient of friction, for example, is 0.7 when the road surface is dry and 0.5 when the road surface is wet.

The notification area 37 is a rectangular area similar to the alert area 36. X1n and Y1n in FIG. 3 are the length of the long side and the length of the short side of the notification area 37, respectively. X1n and Y1n can be expressed as follows.

$$X 1 n [ m ] = X 1 w [ m ] + α2 [ m ] \\ Y 1 n [ m ] = Y 1 w [ m ] + α3 [ m ]$$

α2 and α3 are margins in the travel direction of the vehicle relative to the warning area 36 and the vehicle width direction, respectively.

By setting the notification area 37 and the warning area 36 as described above, the controller 12 of the traffic monitoring apparatus 10 can send a danger notification to the vehicle 30 when the notification area 37 and the exclusive area 55 for the mobile object 50 overlap with each other. The controller 12 can also send an alert to the vehicle 30 of a higher level of danger than the notification when the warning area 36 and the exclusive area 55 for the mobile object 50 overlap with each other. The vehicle 30 can inform the driver of the danger in two stages with a notification and an alert. If the vehicle 30 is an autonomous vehicle, the vehicle 30 may perform collision avoidance maneuvers in different ways in response to notifications and alerts. Different methods include slowing down, changing course, and stopping. For example, the vehicle 30 may decelerate when notified and stop when alerted.

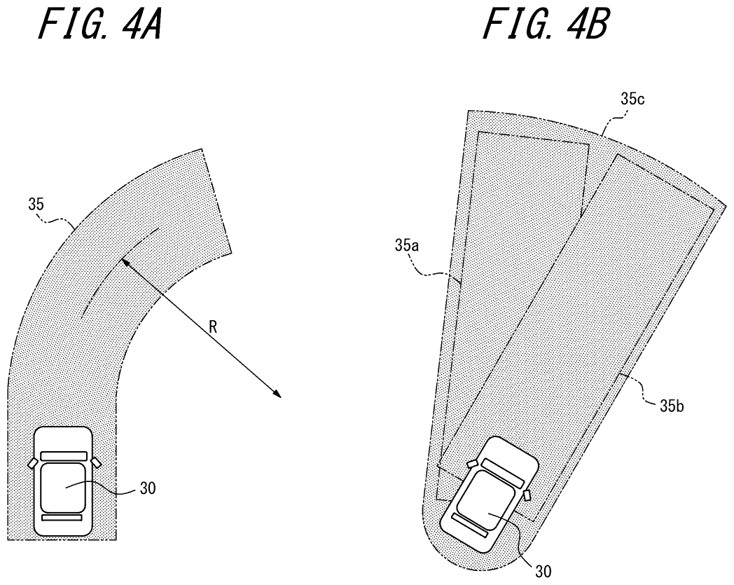

The following is an explanation of how the exclusive area 35 is set up when the vehicle 30 changes the travel direction using FIGS. 4A and 4B. First, when the travel information for the vehicle 30 includes information on the steering angle of the vehicle 30, the controller 12 calculates the front wheel position turning radius R according to the following formula.

$$R [ m ] = L [ m ] / sin θ$$

where L is the wheelbase, i.e., the length from the center of the front wheels to the center of the rear wheels of the vehicle 30. θ is the front wheel rudder angle.

As shown in FIG. 4A, the controller 12 sets an exclusive area 35 that curves in an arc so that the length along the circumference of the front wheel position turning radius R is X1w, as determined by the aforementioned formula.

As shown in FIG. 4B, the controller 12 may tilt the exclusive area 35a calculated for the vehicle 30 traveling straight ahead in the travel direction to make the exclusive area 35b after the change in travel direction. This method can be employed when the travel information for the vehicle 30 does not include the front wheel steering angle θ.

In addition, the controller 12 may retain the angle information before changing the travel direction for a certain period of time. The controller 12 may set a fan-shaped exclusive area 35c that encompasses two exclusive areas 35a and 35b calculated based on the current travel direction and the travel direction before the predetermined time, as the exclusive area 35.

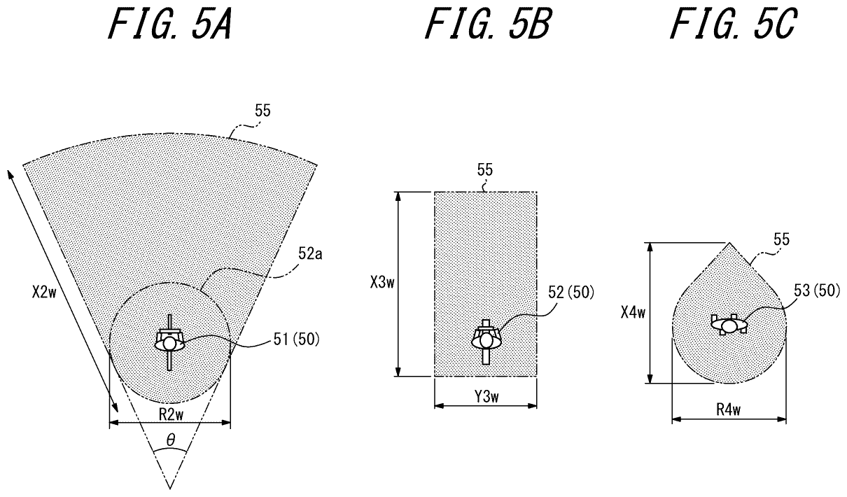

FIGS. 5A to 5C illustrate an example of how to set up the exclusive areas 55 for different types of mobile objects 50 other than the vehicle 30.

If the mobile object 50 is a bicycle 51, the controller 12 sets the ratio of the width of the exclusive area 55 in the direction vertical to the travel direction of the bicycle 51 to the length of the exclusive area 55 in the travel direction higher as the speed of the bicycle 51 decreases. This is because the bicycle 51 is more likely to wobble, change the direction suddenly, or fall over as the speed of the bicycle 51 decreases. The controller 12 may set the exclusive area 55 to include a circular area 52a corresponding to a wobble, etc. centered on the bicycle. As shown in FIG. 5A, the controller 12 can set the exclusive area 55 to a shape that widens toward the travel direction. This is because the bicycles 51 are prone to unpredictable changes in travel direction. When the speed of the bicycle 51 is high, the controller 12 can set the ratio of the width vertical to the travel direction to the length of the exclusive area 55 in the travel direction to be small. For example, the exclusive area 55 may be in the shape of a portion of a fan shape that extends from left to right, centered in the travel direction. The controller 12 can set the central angle θ of the fan shape to be smaller the faster the speed of the bicycle 51 is.

For example, when X2w and R2w in FIG. 5A are, respectively, the total length of the exclusive area 55 for the bicycle 51 and the width of the exclusive area 55 at the position of the bicycle 51, X2w and R2w can be set by the following formula.

$$X 2 w [ m ] = total mobile object length [ m ] + reaction distance [ m ] + braking distance [ m ] \\ R 2 w [ m ] = mobile object speed [ m / s ] \times β1 [ s ]$$

The central angle θ of the fan shape is set according to the speed of the mobile object.

If the mobile object 50 is a PMV 52, as shown in FIG. 5B, the controller 12 can set the exclusive area 55 to be a rectangle with long sides in the travel direction. X3w and Y3w are the lengths of the long and short sides of the exclusive area 55, respectively. X3w and Y3w can be set by the following formula. Y3w, the width of the exclusive area 55 vertical to the travel direction, is set larger as the speed of the PMV 52 is higher. There are various forms of PMV 52, and the shape of the exclusive area may be changed to match the form of the PMV 52. For example, it can be shaped more like a bicycle 51 if it is expected to wobble at low speeds, as in the case of a kick-skater, or more like a pedestrian 53 if it can change direction on the spot, as in the case of a wheelchair.

$$X 3 w [ m ] = total mobile object length [ m ] + reaction distance [ m ] + braking distance [ m ] \\ Y 3 w [ m ] = mobile object speed [ m / s ] \times β2 [ s ]$$

If the mobile object 50 is a pedestrian 53, as shown in FIG. 5C, the controller 12 can set the exclusive area 55 to be a circular shape with a portion of the circle centered at the position of the pedestrian 53 protruding in the travel direction of the pedestrian 53. The pedestrian 53 may always change the travel direction abruptly. Therefore, the basic shape of the exclusive area 55 for the pedestrian 53 can be circular. When the pedestrian 53 stops, the protruding portion of the exclusive area 55 disappears and the entire area becomes circular. X4w and R4w indicate the length of the exclusive area 55 for the pedestrian 53 in the travel direction and the width of the exclusive area 55 (i.e., the diameter of the circular portion) at the position of the pedestrian 53, respectively. X4w and R4w can be set as follows.

$$X 4 w = mobile object speed [ m / s ] \times β3 [ s ] + α4 [ m ] \\ R 4 w = mobile object speed [ m / s ] \times β3 [ s ]$$

### (Traffic Monitoring Method Procedures)

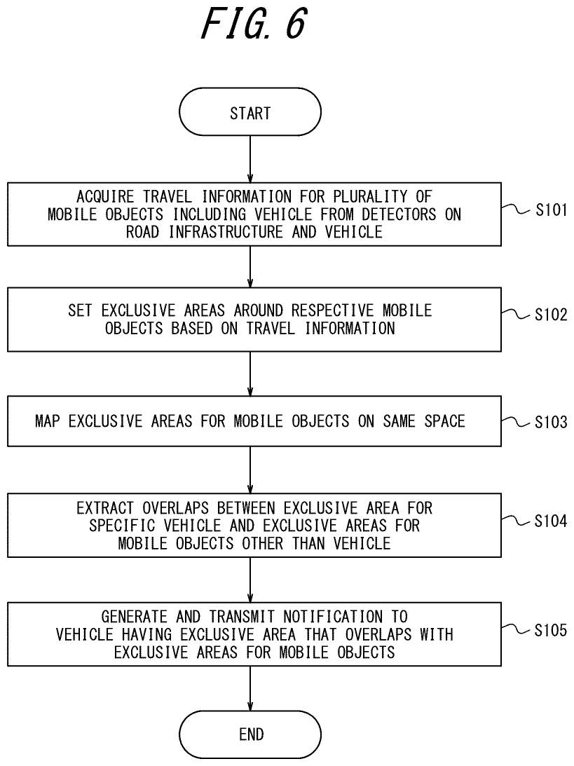

An example of a procedure of the traffic monitoring method performed by the controller 12 of the traffic monitoring apparatus 10 is described using the flowchart of FIG. 6. The method illustrated in the flowchart of FIG. 6 can be performed according to a program by a processor included in the controller 12 of the traffic monitoring apparatus 10. Such a program may be stored in a non-transitory computer readable medium.

First, the controller 12 acquires the travel information for the mobile objects 50 from the detectors 20 on the road infrastructure and the vehicles 30 via the communication interface 11 (S101). The mobile objects 50 include the vehicle 30. The travel information includes information on the positions, speeds, and travel directions of the mobile objects 50. The travel information may further include information on the types of the mobile objects 50, the wet/dry condition of the road surface on which the mobile objects 50 pass, and the steering angles if the mobile objects 50 are the vehicles 30.

The controller 12 sets exclusive areas 55 around each of the mobile objects 50 based on the acquired travel information (S102). The exclusive area 55 extends from the position of the mobile object 50 toward the travel direction of the mobile object 50 with a length calculated based on the speed. If the travel information includes information on the wet/dry condition of the road surface on which the mobile object 50 passes, the controller 12 may set the length of the exclusive area 55 in the travel direction of the mobile object 50 longer when the road surface is wet than when the road surface is dry. If the travel information includes the types of the mobile objects 50, the controller 12 may set the exclusive areas 55 to the shapes and dimensions according to the types of the mobile objects 50. When the travel information includes information on the steering angle of the vehicle 30, the controller 12 may set the exclusive area 35 for the vehicle 30 as an area containing an arc-shaped region curved with a curvature corresponding to the steering angle.

The controller 12 maps the exclusive areas 55 for the respective mobile objects 50 to the same space that corresponds to the actual positions of the mobile objects 50 (S103). The same space can be a virtual two-dimensional space that does not include the height direction. Height information may also be added to the mapping in cases where collisions do not occur in the height direction, such as three-dimensional intersections. The controller 12 may map the exclusive areas 55 for the detected mobile objects 50 for the entire area to be monitored by the traffic monitoring apparatus 10. The controller 12 may map only the exclusive areas 55 for the mobile objects 50 passing around a particular intersection to the same space.

The controller 12 detects the overlap between the exclusive area 35 for the vehicle 30 mapped in the same space and the exclusive areas 55 for the mobile objects 50 other than that vehicle 30 (S104). If there are overlaps between the exclusive area 35 and the exclusive areas 55, the controller 12 determines that there is a risk of a collision between the vehicle 30 and the mobile objects 50.

For a vehicle 30 with an exclusive area 35 that overlaps the exclusive area 55 for the mobile object 50, the controller 12 generates a notification of the danger of collision. The controller 12 sends the notification via the communication interface 11 (S105). If the exclusive area 35 for the vehicle 30 includes multiple areas, as shown in FIG. 3, the controller 12 may provide multi-step notification to the vehicle 30. In other words, the controller 12 may generate a notification of different importance each time a different area overlaps the exclusive area 55 for the mobile object 50. The controller 12 may continuously send notifications to the vehicle 30 until the overlap between the exclusive area 35 for the vehicle 30 and the exclusive area 55 for the mobile object 50 is resolved.

The controller 12 may transmit the risk of a collision between the vehicle 30 and the mobile object 50 to the vehicle 30 as well as to the infrastructure equipment and the terminal apparatus selected as appropriate. The infrastructure equipment includes signal lights, display boards, and loudspeakers installed on road infrastructure. Terminal apparatuses are information terminals, such as smartphones and wearable devices, and welfare equipment equipped with information and communication functions that are carried by specific transportation participants. Traffic participants include drivers of the vehicles 30, users of the bicycles 51 or the PMVs 52, or the pedestrians 53. Welfare equipment may include white canes and hearing aids with navigation functions. Infrastructure equipment and terminal apparatus may provide appropriate notifications or warnings to traffic participants to reduce the likelihood of collisions.

When a specific vehicle 30 receives a notification from the traffic monitoring apparatus 10 and slows down or stops, the exclusive area 35 shrinks. This allows the notification from the traffic monitoring apparatus 10 to the vehicle 30 to be cancelled when the overlap between the exclusive area 35 for the vehicle 30 and the exclusive area 55 for the mobile object 50 is resolved.

As described above, according to the embodiment of the present disclosure, technology for avoiding the collision in road traffic can be improved. The traffic monitoring apparatus 10 of the present disclosure sets exclusive areas 35 and 55 for respective mobile objects 50 including a vehicle 30, and notifies when these exclusive areas 35 and 55 overlap. Therefore, the traffic monitoring apparatus 10 of the present disclosure can perform stable collision occurrence risk determination even when the exclusive area is smaller than when the exclusive area 35 is set only for the own vehicle. Thus, the traffic monitoring apparatus 10 of the present disclosure can reduce the occurrence of unnecessary deceleration and stopping of the vehicle 30.

In the traffic monitoring system 1 of the present disclosure, the detector 20 installed on the road infrastructure detects travel information for mobile objects 50, which enables the traffic monitoring apparatus 10 to determine the risk of a collision between a vehicle 30 and a mobile object 50 other than the vehicle 30. Since the traffic monitoring apparatus 10 integrates the travel information for the mobile objects 50 acquired from a large number of detectors 20, it can also notify the vehicle 30 of the risk of collision even for the mobile objects 50 located in blind spots due to buildings or other objects from the vehicle 30.

Furthermore, the traffic monitoring apparatus 10 of the present disclosure can set up an exclusive area 55 with a shape suitable for the operation of the mobile object 50, depending on the type of the mobile object 50. This improves the accuracy of determining the risk of collision of the vehicle 30 with the mobile object 50. In particular, when the mobile object 50 is a bicycle 51 traveling at low speed, the shape of the exclusive area 55 is set taking into account the possibility of wandering and changing course, thus further reducing the risk of collision with the vehicle 30.

The traffic monitoring apparatus 10 can also set an exclusive area 35 according to the steering angle of the vehicle 30. This means that when the vehicle 30 changes travel direction, it will no longer overlap with the exclusive area 55 for the mobile object 50 located in front of it in the straight ahead direction. This means that the traffic monitoring apparatus 10 does not have to notify the vehicle 30 with useless warnings compared to conventional systems that predict collisions based on the current travel direction of the vehicle 30 and the distance to the object located in front.

Furthermore, if the vehicle 30 is an autonomous vehicle, the traffic monitoring system 1 can share the exclusive areas 55 for the mobile objects 50 around the vehicle 30 via wireless communication. This allows the traffic monitoring system 1 to more smoothly support automated driving of the vehicles 30.

Additionally, the present disclosure is not limited to the above embodiment, and various modifications and revisions may be implemented. For example, functions or the like included in each element, each step, or the like can be rearranged without logical inconsistency, and a plurality of elements, steps, or the like can be combined into one or divided.

Although the above embodiment covers collision avoidance between a vehicle and other mobile objects, the present disclosure may also cover collision avoidance between mobile objects other than vehicles. In such cases, information pertaining to the travel of mobile objects can be detected by sensors deployed on the road infrastructure. Sensors can employ any sensing devices, including cameras, LiDAR, etc. Notification to mobile objects can be not only by communication to them, but also by front-end devices or smartphone placed on the road infrastructure. Front-end devices include, for example, traffic signals, speakers, and LED dials. This eliminates the need to equip the mobile object with special equipment.

1. A traffic monitoring apparatus comprising:
a communication interface configured to:
acquire travel information pertaining to travel of a plurality of mobile objects including a vehicle; and
communicate with the vehicle; and
a controller configured to:
set exclusive areas around the mobile objects based on the travel information; and
generate a notification to be transmitted to the vehicle when an exclusive area around the vehicle and one or more exclusive areas for the mobile objects other than the vehicle overlap with each other.

2. The traffic monitoring apparatus according to claim 1, wherein the travel information includes information on positions of the mobile objects, speeds of the mobile objects, and travel directions of the mobile objects, and the controller is configured to set, based on the travel information, exclusive areas that extend from the positions of the mobile objects in the travel directions of the mobile objects with lengths according to the speeds of the mobile objects.

3. The traffic monitoring apparatus according to claim 2, wherein the travel information further includes information on types of the mobile objects, and the controller is configured to set shapes of the exclusive areas based on the types of the mobile objects.

4. The traffic monitoring apparatus according to claim 3, wherein the controller is configured to, when a type of a mobile object is a bicycle, set a ratio of a width of an exclusive area in a direction vertical to a travel direction of the bicycle to a length of the exclusive area in the travel direction higher as a speed of the mobile object decreases.

5. A traffic monitoring system comprising:
the traffic monitoring apparatus according to claim 1;
a detector configured to detect the travel information; and
the vehicle,
wherein the vehicle is an autonomous vehicle capable of at least partially autonomous driving, and upon receiving a notification from the traffic monitoring apparatus, the vehicle is configured to use the notification to perform control of driving.

6. A method, by a processor, for improving travel mobility as a service (MaaS), comprising processing steps executed by the traffic monitoring apparatus according to claim 1.
